(19) United States
(12) Patent Application Publication
(10) Pub. No.: US 2018/0114031 A1
(43) Pub. Date: Apr. 26, 2018

(54) ELECTRONIC APPLIANCE

(71) Applicant: KYOCERA Document Solutions Inc., Osaka (JP)

(72) Inventor: Yoshio MORITA, Osaka (JP)

(21) Appl. No.: 15/788,162

(22) Filed: Oct. 19, 2017

(30) Foreign Application Priority Data
Oct. 21, 2016 (JP) 2016-207290

(51) Int. Cl. G06F 21/62; G06F 21/31

(52) U.S. Cl. CPC G06F 21/6218; G06F 21/31

(57) ABSTRACT

An electronic appliance includes a login processing unit that (a) shifts an operation mode to an administrator login mode when an administrator user has logged in with administrator authority, (b) shifts the operation mode to a temporary logout mode when a predetermined mode shift command and the like of the administrator user have been detected in the administrator login mode, and (c) returns the operation mode to the administrator login mode when the administrator user has succeeded in the user authentication with administrator authority in the temporary logout mode, and a control unit that (a) performs a maintenance process according to a command of the administrator user in the administrator login mode, and (b) refuses all new commands of a user while continuously performing the maintenance process in the temporary logout mode.

### CROSS-REFERENCE TO RELATED APPLICATION

This application is based upon and claims the benefit of priority from Japanese Patent Application No. 2016-207290 filed on Oct. 21, 2016, the entire contents of which are incorporated herein by reference.

### BACKGROUND

The technology of the present disclosure relates to an electronic appliance.

In an electronic appliance, when a user has logged in with administrator authority, the user can allow the electronic appliance to perform a maintenance process such as appliance setting and appliance adjustment work prohibited to general users.

### SUMMARY

An electronic appliance according to one aspect of the present disclosure includes a login processing unit and a control unit. The login processing unit (a) shifts an operation mode to an administrator login mode when an administrator user has logged in by succeeding in user authentication with administrator authority, (b) shifts the operation mode to a temporary logout mode when a predetermined mode shift command of the administrator user or a predetermined length of non-operation period has been detected in the administrator login mode, and (c) returns the operation mode to the administrator login mode when the administrator user has succeeded in the user authentication with administrator authority in the temporary logout mode. The control unit (a) performs a maintenance process according to a command of the administrator user and refuses a command of a user other than the administrator user in the administrator login mode, and (b) refuses all new commands of a user while continuously performing the maintenance process, which has been started by the administrator user in the administrator login mode, in the temporary logout mode.

### BRIEF DESCRIPTION OF THE DRAWINGS

FIG. 1 is a block diagram illustrating a configuration of an electronic appliance according to an example of an embodiment.

FIG. 2 is a flowchart for explaining an operation of an electronic appliance illustrated in FIG. 1.

### DETAILED DESCRIPTION

Hereinafter, an embodiment according to the technology of the present disclosure will be described on the basis of the drawings.

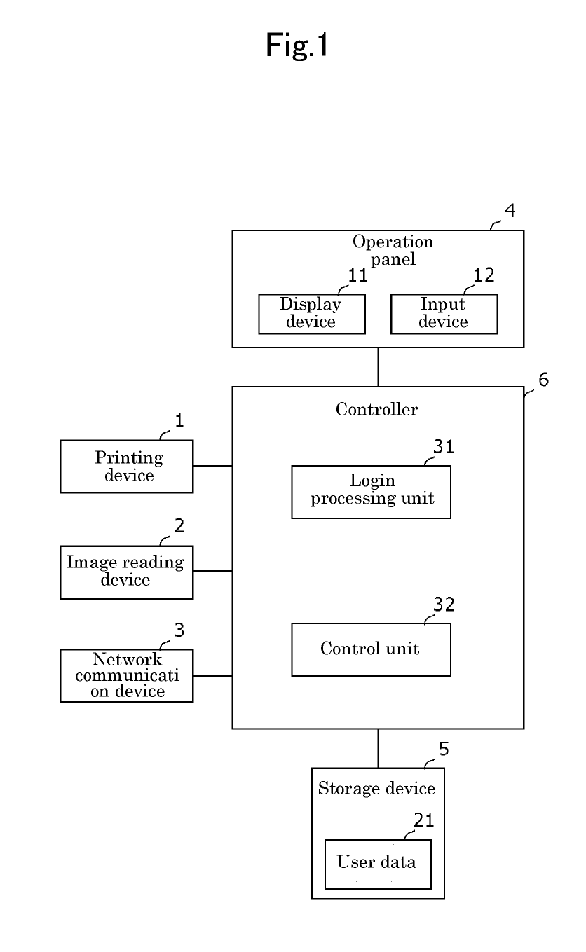

FIG. 1 is a block diagram illustrating a configuration of an electronic appliance according to an example of an embodiment. The electronic appliance illustrated in FIG. 1 is an image forming apparatus, such as a multifunctional peripheral, which is available only by a registered user and limits processing executable according to user authority (general user authority or administrator authority).

The electronic appliance illustrated in FIG. 1 includes a printing device 1, an image reading device 2, a network communication device 3, an operation panel 4, a storage device 5, and a controller 6.

The printing device 1 is an internal device that prints an image on a print sheet with characteristics based on various types of setting.

The image reading device 2 is an internal device that reads a document image from a document with characteristics based on various types of setting.

The network communication device 3 is an internal device that performs data communication with an external device via a network with characteristics based on various types of setting.

The operation panel 4 is a user interface installed on a housing surface of the electronic appliance and includes a display device 11 and an input device 12. The display device is a device, such as a liquid crystal display, which displays a screen including various types of information with respect to a user. The input device 12 is a device, such as a touch panel for a hard key, a soft key and the like, which detects a user operation for inputting commands to the electronic appliance.

The storage device 5 is a nonvolatile storage device and stores user data 21. The user data 21 includes user authentication information (pairs of user IDs and passwords, and the like) corresponding to each registered user and other attribute information (assigned user authority and the like).

The controller 6 includes a microprocessor for executing a control program, an ASIC (Application Specific Integrated Circuit) and the like, and controls the aforementioned internal devices with the microprocessor, the ASIC and the like while performing various processes. The controller 6 operates as a login processing unit 31 and a control unit 32.

The login processing unit 31 displays a login screen on the display device 11, and performs user authentication by comparing user authentication information inputted to the input device 12 by a user with the user authentication information in the user data 21. When succeeding in the user authentication, the login processing unit 31 permits the user's login and displays an operation screen in accordance with user authority on the display device 11. In this way, the user can input commands to the electronic appliance, thereby allowing the electronic appliance to perform processes in accordance with the commands. On the other hand, when failed in the user authentication, the login processing unit 31 continuously displays the login screen on the display device 11, thereby prohibiting the input of commands (other than user authentication information for login) by a user.

The login processing unit 31 (a) shifts an operation mode of the electronic appliance to an administrator login mode when an administrator user has logged in by succeeding in user authentication with administrator authority, (b) shifts the operation mode to a temporary logout mode when a predetermined mode shift command of the administrator user or a predetermined length of non-operation period has been detected in the administrator login mode, and (c) returns the operation mode to the administrator login mode when the administrator user has succeeded in the user authentication with administrator authority in the temporary logout mode.

The control unit 32 (a) performs a maintenance process according to the command of the administrator user, which is inputted to the input device 12 and refuses commands of users other than the administrator user in the administrator login mode, and (b) refuses all new commands of users while continuously performing the maintenance process, which has been started by the administrator user in the administrator login mode, in the temporary logout mode.

Moreover, when accepting a logout command of the administrator user in the administrator login mode, the login processing unit 31 performs a logout process (forced termination and the like of processes being performed by a logged in user) and shifts the operation mode to a logout mode (a mode in which a login screen is displayed to indicate a waiting state without user's login).

Moreover, in this embodiment, in the administrator login mode, the login processing unit 31 displays an operation part (for example, a soft key) for inputting a mode shift command for the temporary logout mode on the display device 11. The login processing unit 31 may be configured to display the operation part only for a period in which the maintenance process is performed in the administrator login mode, and not to display the operation part for a period in which the maintenance process is not performed. Furthermore, the login processing unit 31 may be configured to display the operation part only for a period in which a specific maintenance process (a pre-designated maintenance process with a long required time, a maintenance process requiring an operation of the administrator user after process termination, and the like) is performed.

Moreover, in this embodiment, in the temporary logout mode, the login processing unit 31 displays an input screen for user authentication (a screen similar to the login screen and having input fields for user authentication information dedicated for the administrator user) on the display device 11.

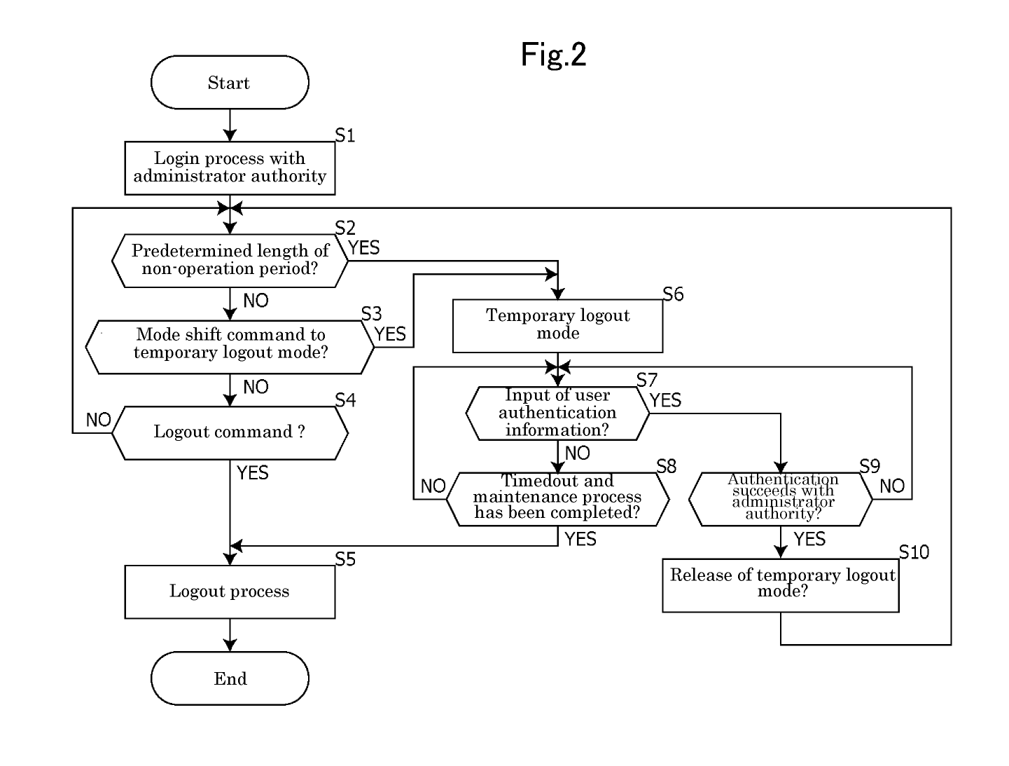

Next, the operation of the aforementioned electronic appliance will be described. FIG. 2 is a flowchart for explaining the operation of the electronic appliance illustrated in FIG. 1.

When the electronic appliance starts to operate, the login processing unit 31 sets an initial operation mode to the logout mode and displays the login screen on the display device 11.

When a user (herein, the administrator user) inputs his/her user authentication information (herein, a user ID and a password) to the login screen, the login processing unit 31 performs the login process (step S1).

In the login process, the login processing unit 31 first acquires the user authentication information by using the input device 12 and performs user authentication of the user with the user data 21. When succeeding the user authentication, the login processing unit 31 permits the user's login, specifies user authority of the user, and displays an operation screen in accordance with the user authority on the display device 11. On the other hand, when failed in the user authentication, the login processing unit 31 continues to display the login screen.

In a case of a user having administrator authority, when succeeding in user authentication, login with the administrator authority is permitted and an operation screen for the administrator user is displayed. Then, the administrator user having logged in with the administrator authority inputs a desired command to the input device of the operation panel 4, thereby allowing the control unit 32 to perform the maintenance process.

When the user having administrator authority logs in, the login processing unit 31 shifts the operation mode to the administrator login mode, and for example, displays an operation part for inputting a mode shift command to the temporary logout mode on the display device 11 for a period in which the maintenance process is being performed.

Then, the login processing unit 31 monitors (a) whether a predetermined length of non-operation period has been detected (step S2), (b) whether the input of the mode shift command to the temporary logout mode with respect to the aforementioned operation part has been detected in the input device 12 (step S3), and (c) whether the input of the logout command has been detected in the input device 12 (a soft key or a hard key) (step S4).

When the input of the logout command has been detected in the input device 12 (step S4), the login processing unit 31 performs the logout process (step S5) to shift the operation mode to the logout mode.

Furthermore, when the predetermined length of non-operation period has been detected (step S2) and the input of the mode shift command to the temporary logout mode with respect to the aforementioned operation part has been detected in the input device 12 (step S3), the login processing unit 31 shifts the operation mode to the temporary logout mode (step S6).

For example, in the administrator login mode, when the administrator user is separated from the electronic appliance after performing the aforementioned mode shift command or when the administrator user is separated from the electronic appliance without performing the aforementioned mode shift command and a non-operation period has passed, the operation mode is shifted from the administrator login mode to the temporary logout mode.

In the temporary logout mode, the login processing unit (a) displays an input screen for inputting user authentication information (herein, a user ID and a password) for the administrator user on the display device 11, (b) continues an incomplete maintenance process being performed as a background process, and (c) refuses all new commands (commands via a network and commands from the operation panel 4) from users.

Furthermore, in the temporary logout mode, the login processing unit 31 monitors whether the input of the user authentication information to the input screen has been detected (step S7), and monitors whether a predetermined length of non-input period, in which the user authentication information is not inputted to the input screen, has been detected and all the maintenance process has been completed (step S8).

When the input of the user authentication information to the input screen has been detected in the temporary logout mode (step S7), the login processing unit 31 determines whether user authentication based on the inputted user authentication information has been succeeded with reference to the user authentication information of the logged in administrator user in the user data 21 (step S9). When failed in the user authentication, the login processing unit 31 returns to step S7 and continues to monitor whether the user authentication information has been inputted.

When succeeded in the user authentication, the login processing unit 31 returns the operation mode to the administrator login mode from the temporary logout mode (step S10), and starts the monitoring in steps S2 to S4 again.

On the other hand, when the predetermined length of non-input period, in which the user authentication information is not inputted to the input screen, has been detected and the maintenance process has been completed (step S8), the login processing unit 31 automatically performs the logout process (step S5) and shifts the operation mode to the logout mode.

In addition, when a user has succeeded in user authentication with not administrator authority but general user authority, the login processing unit 31 shifts the operation mode to a general login mode and does not display the aforementioned operation part for the temporary logout mode on the display device 11. In this way, shift to the temporary logout mode by a general user is prohibited. Furthermore, in a case where a user has logged in with the general user authority, when a predetermined length of non-operation period is detected, the login processing unit 31 immediately performs the logout process and returns the operation mode to the logout mode.

Meanwhile, in the related electronic appliance, a maintenance process requires an operation of an administrator at the time of processing completion, and when such a maintenance process is started to be performed, the administrator needs to wait in the electronic appliance until the maintenance process is completed. For example, there is a case where it is determined whether an administrator confirms and approves results of modification and adjustment of various types of setting by the maintenance process and inputs the determination result. If the administrator user is separated from the electronic appliance before the maintenance process is completed, other users (a general user and the like) may use the electronic appliance in the meantime, resulting in a problem that any errors occur in the electronic appliance due to the incompletion of the maintenance process. Therefore, when such a maintenance process is required for a long time, since the administrator is not able to perform other works (a maintenance work and the like for other electronic appliances), the administrator has difficulty in efficiently performing the maintenance work.

However, according to the aforementioned embodiment, the login processing unit 31 (a) shifts the operation mode to the administrator login mode when an administrator user has logged in by succeeding in user authentication with administrator authority, (b) shifts the operation mode to the temporary logout mode when a predetermined mode shift command of the administrator user or a predetermined length of non-operation period has been detected in the administrator login mode, and (c) returns the operation mode to the administrator login mode when the administrator user has succeeded in the user authentication with administrator authority in the temporary logout mode. The control unit 32 (a) performs the maintenance process according to commands of the administrator user and refuses commands of users other than the administrator user in the administrator login mode, and (b) refuses all new commands of users while continuously performing the maintenance process, which has been started by the administrator user in the administrator login mode, in the temporary logout mode.

In this way, the administrator user can be separated from the electronic appliance while preventing inappropriate use by other users during the maintenance work, thereby efficiently performing the maintenance work.

It is noted that various modifications and corrections of the aforementioned embodiment are apparent to a person skilled in the art. Such modifications and corrections may be performed without departing from the spirit and scope of the subject and weakening its intended advantages. In other words, it is intended that such modifications and corrections are included in the scope of the claims.

For example, in the aforementioned embodiment, when the maintenance process, which has been started by the administrator user in the administrator login mode, is completely terminated in the temporary logout mode, the login processing unit 31 may immediately and automatically perform the logout process and may shift the operation mode of an electronic appliance to the logout mode. Moreover, in such a case, when the maintenance process started by the administrator user in the administrator login mode is completely terminated in the temporary logout mode, the login processing unit 31 may select whether to automatically perform the logout process and shift the operation mode to the logout mode or to continue the temporary logout mode, on the basis of commands of the administrator user.

What is claimed is:

1. An electronic appliance comprising:
a login processing unit that (a) shifts an operation mode to an administrator login mode when an administrator user has logged in by succeeding in user authentication with administrator authority, (b) shifts the operation mode to a temporary logout mode when a predetermined mode shift command of the administrator user or a predetermined length of non-operation period has been detected in the administrator login mode, and (c) returns the operation mode to the administrator login mode when the administrator user has succeeded in the user authentication with administrator authority in the temporary logout mode; and
a control unit that (a) performs a maintenance process according to a command of the administrator user and refuses a command of a user other than the administrator user in the administrator login mode, and (b) refuses all new commands of a user while continuously performing the maintenance process, which has been started by the administrator user in the administrator login mode, in the temporary logout mode.

2. The electronic appliance of claim 1, wherein the login processing unit (a) performs a logout process when accepting a logout command of the administrator user in the administrator login mode, and (b) automatically performs the logout process when the maintenance process started by the administrator user in the administrator login mode is completely terminated.

3. The electronic appliance of claim 2, wherein when the maintenance process started by the administrator user in the administrator login mode is completely terminated in the temporary logout mode, the login processing unit selects whether to automatically perform the logout process or to continue the temporary logout mode, on a basis of a command of the administrator user.

4. The electronic appliance of claim 1, further comprising:
a display device,
wherein the login processing unit (a) displays an operation part for inputting the mode shift command for the temporary logout mode on the display device in the administrator login mode, and (b) displays an input screen for the user authentication on the display device in the temporary logout mode.

5. The electronic appliance of claim 4, wherein the login processing unit displays the operation part only for a period in which the maintenance process is performed in the administrator login mode, and does not display the operation part for a period in which the maintenance process is not performed.

6. The electronic appliance of claim 5, wherein the login processing unit displays the operation part only for a period in which a specific maintenance process is performed.
